(19) United States
(12) Patent Application Publication
(10) Pub. No.: US 2009/0150905 A1
(43) Pub. Date: Jun. 11, 2009

(54) INTEGRATING NON-XML PROTOCOLS INTO WEB BROWSING APPLICATIONS

(75) Inventors: LIN LIN, Belleville (CA); PING LIN, Belleville (CA)

Correspondence Address: RIDOUT & MAYBEE LLP, 225 KING STREET WEST, 10TH FLOOR, TORONTO, ON, M5V 3M2, CA

(73) Assignee: NORTEL NETWORKS, LIMITED, St. Laurent (CA)

(21) Appl. No.: 11/954,097

(22) Filed: Dec. 11, 2007

(51) Int. Cl. G06F 9/46

(52) U.S. Cl. 719/313

(57) ABSTRACT

By using a predetermined tree structure to map elements of messages in a non-XML protocol to elements of appropriately structured messages in a data interchange format that facilitates script access, web-based applications programmed in scripting languages may be allowed to bypass protocol translation servers and communicate directly with network elements that only use non-XML protocol messages.

### FIELD OF THE INVENTION

The present application relates generally to web browsing applications and, more specifically, to the integration of non-XML protocols into such applications.

### BACKGROUND OF THE INVENTION

Increasingly, communications functions such as telephony, e-mail communication, teleconferencing and instant messaging are migrating from taking place on widely varied networks or being enabled by distinct servers to taking place on the same network and being enabled by a single server.

At the user end, a single client application may be suited to unified messaging by combining a view to e-mail messages, voice mail messages and fax messages in the same application. Furthermore, the client application may allow for voice calls using Voice over Internet Protocol (VoIP) telephony, enterprise instant messaging, conferencing, contact management and presence functionality.

Software distribution is undergoing a paradigm shift. Rather than receiving stand-alone software applications as individual packages of executable files and support files that are tailored to particular operating systems, write-once, run anywhere languages and corresponding script code are allowing for applications to be downloaded on an as-needed basis and executed from within a browsing application.

An example browser-based application allows for reading and organizing e-mail messages. Further example browser-based applications allow, for example, for management and review of libraries of digital photographs or digital music. From the perspective of the distributor, browser-based applications allow for dynamic advertising and, in some cases, advertising based on key words found in use on that which is being managed by the browser-based application. Such dynamic advertising can lead to income significant enough that the application can be distributed without cost to the end user. Advantageously for the user, the distributor, once comfortable with the advertising income, is typically required to frequently update and improve the software to stay competitive so as not to lose users to other, similarly distributed applications. It is unsurprising, then, that those involved in making a unified communication client would turn attention to developing the unified communication client as a browser-based application. However, there are some limitations.

A stand-alone (i.e., non-browser-based) communication client places a voice call over a data network through the use of a protocol specific to the task. One such protocol is the known Session Initiation Protocol (SIP). A first network entity, for instance, a personal computer (PC) of a user, executes the stand-alone communication client, which can use SIP to setup a voice call over a data network to a second network entity that has been configured to use SIP as well. The two network entities exchange commands, requests and responses and eventually establish a communication link over which a voice call can take place between the user of the PC and a user of the second network entity. At the end of the call, the two network entities exchange commands, requests and responses to remove the previously established communication link.

To place a voice call over a data network using a communications client implemented as a browser-based application requires that the browser-based application issue and receive commands, requests and response according to the selected communications protocol. Unfortunately, the typical web-browsing application is configured to use, for a data interchange format, the known Hyper-Text Transfer Protocol (HTTP) and the known Extensible Markup Language (XML) protocol for sending requests and processing responses. Notably, while HTML may be considered to be in a class of protocols known as XML protocols, protocols typically used for data network telephony may be considered to be in a much wider class of protocols known as non-XML protocols. The typical web-browsing application is not configured to use such non-XML protocols as represented by the above SIP example.

The solution thus far has been to establish a task-specific web server. A browser-based communication client may send commands to the web server in a data interchange format (i.e., XML) that is capable of being processed by the web browsing application. The web server can then translate the received commands into the appropriate web protocol and send the commands to the intended destination network entity. Responses from the intended destination network entity are received by the web server and translated by the web server before being forwarded to the browser-based communication client.

Clearly, efficiency may be gained by eliminating the intermediate servers for a data network call involving a browser-based communication client.

### SUMMARY

Many tree structure definitions exist for use by script code in a web page to manipulate data. It is proposed herein that messages (e.g., commands, requests, responses, etc.) in many protocols can be converted to a specific data interchange format according to a predetermined tree structure. Example protocols include those based on the Internet Engineering Task Force Request for Comments known as “RFC2822”, e.g., the known Session Initiation Protocol (SIP), and binary protocols containing information elements. When messages are represented in an appropriate data interchange format, the messages may be manipulated by scripting languages such as JavaScript. When messages may be manipulated by scripting languages, the need for intermediate servers for a data network call can be obviated.

In accordance with an aspect of the present invention, there is provided an XMLHttpRequest Application Programming Interface (API) operable to process a non-Hyper-Text Transfer Protocol (non-HTTP) uniform resource locator (URL). In other aspects of the present invention, an apparatus is provided for carrying out this method and a computer readable medium is provided for adapting an apparatus to carry out this method.

In accordance with another aspect of the present invention, there is provided a method of sending a message in a non-XML protocol. The method includes receiving user input, based on the user input, generating, in a given data interchange format and according to a predetermined tree structure, a message to be sent, where the given data interchange format facilitates script access and creating an object to contain the message to be sent. The method also includes, through calls to an application programming interface: causing the message to be sent to be translated, according to the predetermined tree structure, to a message in the non-XML protocol; and causing the message in the non-XML protocol to be transmitted. In other aspects of the present invention, an apparatus is provided for carrying out this method and a computer readable medium is provided for adapting an apparatus to carry out this method.

In accordance with a further aspect of the present invention, there is provided a method of handling an incoming message in a non-XML protocol. The method includes receiving the incoming message and, based on the incoming message, generating, in a given data interchange format and according to a predetermined tree structure, a received message, where the given data interchange format facilitates script access. The method further includes invoking a handler to process the received message. In other aspects of the present invention, an apparatus is provided for carrying out this method and a computer readable medium is provided for adapting an apparatus to carry out this method.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Reference will now be made to the drawings, which show, by way of example, embodiments of the invention and in which:

FIG. 1 illustrates a network environment in which a browser-based communication client may arrange a data network voice call according to an embodiment;

FIG. 2 illustrates an example of a SIP message;

FIG. 3 illustrates an example of a result of mapping the SIP message of FIG. 2 to a well-formed XML message;

FIG. 4 illustrates example steps of a method of reacting to receipt of user input that is known to result in the creation of a message to be sent to a destination network entity according to an embodiment of the present invention;

FIG. 5 illustrates steps in an example method of operation for a XMLHttpRequest object, where the example method involves selection of a plug-in;

FIG. 6 illustrates steps in an example method of operation for the plug-in selected in the method of FIG. 5;

FIG. 7 illustrates steps in an example method of handling an incoming message by a plug-in; and

FIG. 8 illustrates an example of a result of mapping the SIP message of FIG. 2 to a JSON message.

### DETAILED DESCRIPTION OF THE EMBODIMENTS

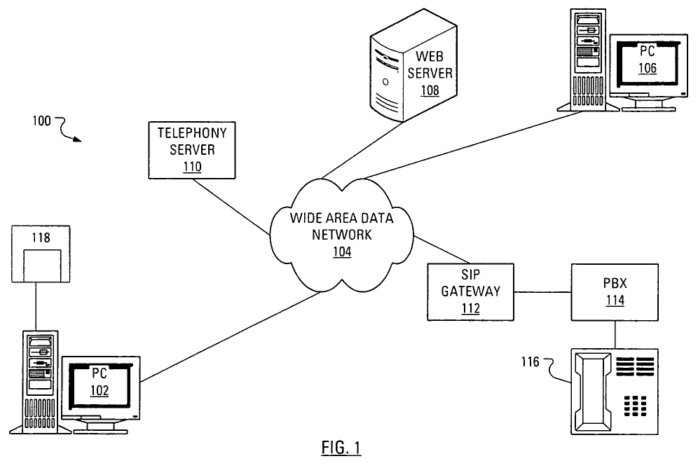

FIG. 1 illustrates a network environment 100 in which a client application may arrange a data network voice call. The client application is executed by a first PC 102, which is communicatively connected to a wide area data network 104, such as the present-day Internet and successor networks. Also connected to the wide area data network 104 is a potential destination network entity in the form of a second PC 106. Another potential destination network entity is represented by a telephone 116 connected to a Private Branch Exchange (PBX) 114. The PBX connects to the wide area data network 104 through a SIP gateway 112. A web server 108 connects to the wide area data network 104 and a telephony-specific web server 110 is illustrated as connected to the wide area data network 104 for purposes of illustrating known ways of arranging a data network voice call. Memory (not shown) in the first PC 102 may be loaded with web browsing software for executing aspects of this invention from a software medium 118 which could be a disk, a tape, a chip or a random access memory containing a file downloaded from a remote source.

It is known that the telephony-specific web server 110 may execute a Servlet container. Available Java Servlet containers include: Tomcat from the Apache Software Foundation of Forest Hill, Md.; WebSphere from IBM of Armonk, N.Y.; and WebLogic® from BEA Systems, Inc. of San Jose, Calif.

Web servers are often configured to execute at least one “servlet”, where a servlet is an object that receives a request and generates a response based on that request. In an example scenario typical of existing arrangements, a servlet executed by the telephony-specific web server 110 receives a call setup (or other) request, from the web browsing application executed at the first PC 102. The call setup request may, for example, be in the form of an HTTP GET method or an HTTP POST method specifying a destination network entity, e.g., the second PC 106. The servlet translates the HTTP call setup request to a SIP call setup request. The servlet then passes the SIP call setup request to the second PC 106. The servlet receives, from the second PC 106, a SIP response to the SIP call setup request. The servlet translates the SIP response to an HTTP response and transmits the HTTP response to the web browsing application at the first PC 102 as a response to the HTTP GET or the HTTP POST.

The disadvantages of a method that uses a servlet at the telephony-specific web server 110 include: the telephony-specific web server 110 may be considered an unnecessary extra hop—the additional time involved slows down call setup; and the request-response interaction pattern is not natural for telephony since, for example, a call setup request can generate a sequence of status messages over time and there can also be unsolicited messages during an active call. It should also be clear that a web server may be considered an unnecessary extra hop without regard to whether or not the web server is based on servlets.

One way around the unnatural interaction problem is to operate at a higher level, i.e., define requests that encompass a full feature. In this way, interactions that do not fall into the request-response pattern are hidden away in the servlet interaction with the destination network entity.

However, this method also has disadvantages, including: the difficulty inherent in hiding all non-request-response interactions from the browsing application—inevitably some non-request-response interactions show through in awkward Application Programming Interface (API) constructions; too little control, in that a good part of the functionality of the destination network entity can be lost depending on how high-level services are defined; too much data hiding, in that the browsing application often has need for information that is present in the underlying protocol messages (e.g., non-request-response interactions), but the underlying protocol messages are inaccessible at the service level.

In overview, it is proposed herein to map, using a predetermined tree structure, a non-XML message to a message in a data interchange format that facilitates script access. Advantageously, each non-XML message may be enclosed in a root element. Where the data interchange format is XML, a well-formed XML message based on a non-XML message may be manipulated by code written in a scripting language such as JavaScript. In the reverse, a well-formed XML message may be converted, according to the predetermined tree structure, to a protocol-specific, non-XML message. Conveniently, a browser-based communication client written in a scripting language may interact with a communication client at a remote network entity to setup a data network voice call without use of translation services provided by an intermediary web server such as the telephony-specific web server 110 of FIG. 1.

At the most basic level, a 1-to-1 mapping may be established between each information element (IE) of a non-XML message and elements of a message in a data interchange format known to facilitate script access, for example, a well-formed XML message. If a given IE occurs only once in a particular non-XML message, a generic XML element may be used with an “ID attribute” set to the name of the given IE.

A review of communication protocol messages that are suitable candidates for the non-XML messages to be mapped will reveal that many portions of information in the non-XML messages are structured. In the interest of conciseness, hereinafter, the non-XML, communication protocol messages may be referred to as “native” messages.

Examples of structured portions of information in a native message include: a value in a header-value pair; and payload in an IE. Additional child elements can be defined using the predetermined tree structure to make the child elements addressable. Additional attributes can be defined using the predetermined tree structure to make the attributes addressable.

In some instances, when mapping a native message having a list to a well-formed XML message, each item on the list may be placed in a separate child <item> element and the values from multiple headers with the same name may be placed into one element. Note that it is often important to preserve occurrence order in the native message when doing such a mapping. For binary messages, it may be helpful to map field values to their symbolic names in enumerations.

Advantageously, the use of the predetermined tree structure to map a native message to a well-formed XML message allows a script to use an API to access specific parts of the native message according to the predetermined tree structure.

If a browser-based communication client application is developed using JavaScript, then, in operation, a JavaScript object will contain each well-formed XML message resulting from the mapping.

Using the predetermined tree structure, IEs of a native message may be mapped to element IDs of a well-formed XML message contained by a JavaScript object. Accordingly, the element IDs can be accessed directly, by the browser-based communication client application, as fields of the JavaScript object containing the message.

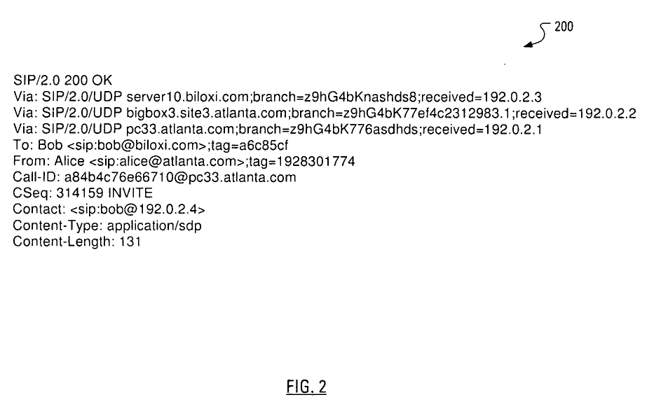

An example of a SIP message is illustrated in FIG. 2.

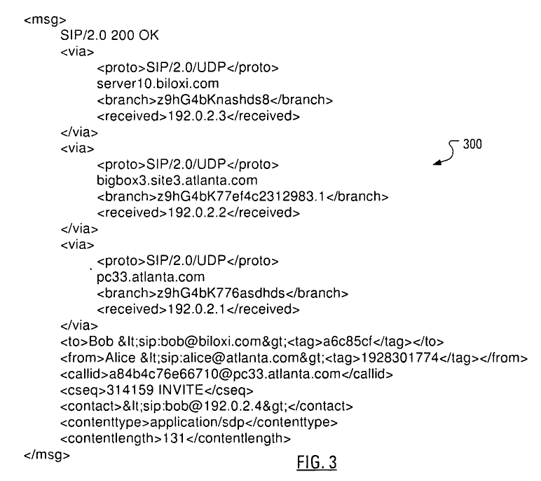

An example of an XML message resulting from mapping the SIP message of FIG. 2 to a well-formed XML message is illustrated in FIG. 3.

It should be clear that the browser-based communication client application may construct a new well-formed XML message, according to the predetermined tree structure, using calls to an API. The new well-formed XML message may later be converted to the native format.

The World Wide Web Consortium (W3C) maintains an XMLHttpRequest Object specification, which defines an API that provides a scripted client functionality for transferring data between a client and a server.

XMLHttpRequest is an API that can be used by executing code developed in JavaScript, and executing code developed in other web browser scripting languages, to transfer XML and other text data to and from a web server using HTTP. The XMLHttpRequest API establishes an independent and asynchronous communication channel between a client side of a web page and a server side of a web page.

The XMLHttpRequest API is an important part of the “Asynchronous JavaScript And XML” (Ajax) web development technique. The XMLHttpRequest API is used by many websites to implement responsive and dynamic browser-based applications.

It is proposed herein to extend the XMLHttpRequest API to make use of messages expressed according to the native-to-XML mapping described above.

A plug-in architecture is proposed herein for the implementation of the XMLHttpRequest API. A protocol-specific plug-in may be implemented for handling translation between the XML format and one of many native formats.

The XMLHttpRequest API includes a method called “open”, which may be referred to as “XMLHttpRequest.open”. The XMLHttpRequest API also includes a method called “send”, which may be referred to as “XMLHttpRequest.send”. The send method typically follows the open method.

The XMLHttpRequest API defines a number of parameters for the XMLHttpRequest.open method including: method; URL; async; userName; and password. Note that URL is an acronym for either Uniform Resource Locator.

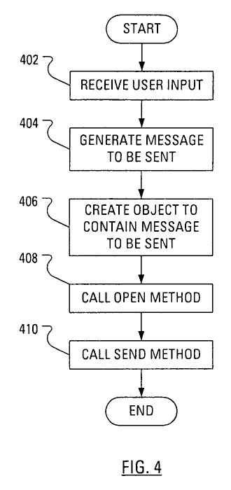

In operation in view of FIG. 4, according to one embodiment, the browser-based communication client application initially receives (step 402) user input that is known to result in the creation of a message to be sent to a destination network entity. Upon receiving the user input, the browser-based communication client application generates (step 404) the message to be sent in a specific data interchange format and according to a predetermined tree structure. In particular, generating the message may involve using an API associated with the predetermined tree structure, or a specific script, to access and update the message.

Furthermore, the browser-based communication client application creates (step 406) a JavaScript object to contain the message to be sent. The browser-based communication client application then sends the message, for instance, to begin a SIP-based data network voice call, by calling (step 408) the open method of the XMLHttpRequest API as follows:
open(‘INVITE’, ‘sip:linlin@nortel.com’, true), which is of the form
open(method, URL, async).

The “method” parameter of the XMLHttpRequest.open method can have a value of “GET”, “POST”, “HEAD”, “PUT”, “DELETE”, or a variety of other HTTP methods listed in the W3C specification. It is proposed herein to extend the XMLHttpRequest.open method to accept additional values for the method parameter.

Currently, a value given to the URL parameter is expected to be a valid HTTP URL. It is proposed herein to extend the XMLHttpRequest.open method to accept non-HTTP URLs. In the example above, sip:linlin@nortel.com is a non-HTTP URL. It is, therefore, proposed herein to extend the XMLHttpRequest.open method to accept SIP URLs.

The “async” parameter of the XMLHttpRequest.open method specifies whether the request message should be handled asynchronously or not—“true” means that script processing is to carry on after the expected XMLHttpRequest.send method, without waiting for a response and “false” means that the script is to wait for a response to the expected XMLHttpRequest.send method before continuing script processing.

The browser-based communication client application follows the open method call to the XMLHttpRequest API with a send method call (step 410) to the XMLHttpRequest API. The only parameter in the XMLHttpRequest.send method is “content”. Accordingly, when the browser-based communication client application calls (step 410) the XMLHttpRequest.send method, the value of the content parameter is the JavaScript object created in step 406, which JavaScript object contains the message to be sent.

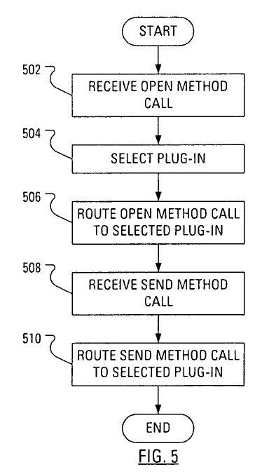

Steps in an example method of operation for a XMLHttpRequest object are illustrated in FIG. 5. Initially, the XMLHttpRequest object receives (step 502) the XMLHttpRequest.open method call from the browser-based communication client application. The XMLHttpRequest object notes the protocol from the URL parameter of the XMLHttpRequest.open method call and selects (step 504) a plug-in specific to the noted protocol. Upon selecting the plug-in, the XMLHttpRequest object then routes (step 506) the XMLHttpRequest.open method call to the selected plug-in. The XMLHttpRequest object then receives (step 508) the XMLHttpRequest.send method call from the browser-based communication client application and routes (step 510) the XMLHttpRequest.send method call to the selected plug-in.

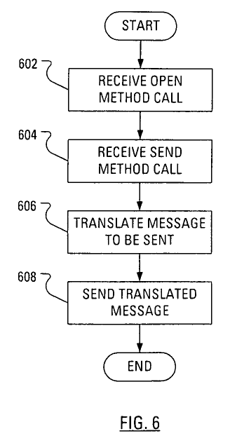

Steps in an example method of operation for a plug-in are illustrated in FIG. 6. Initially, the plug-in receives (step 602) the XMLHttpRequest.open method call. The plug-in also receives (step 604) the XMLHttpRequest.send method call. The plug-in then translates (step 606) the value of the content parameter (i.e., the message to be sent) from XML to the protocol to which the plug-in is specific, thereby producing a translated message. The plug-in then transmits (step 608) the translated message to the URL specified in the XMLHttpRequest.open method call.

As messages in a non-XML protocol arrive at the first PC 102, the browser-based communication client application will be unaware of the arrival. As such, it is expected that a plug-in will be executing and will become aware of the arrival of the message.

In one instance, the sending of the translated message (step 608, FIG. 6) involves establishing a Transport Communication protocol (TCP) session between the first PC 102 and the network entity specified in the URL parameter of the XMLHttpRequest.open method call. The TCP session may be considered a pair of pipes, one pipe for outgoing messages and one pipe for incoming messages. It is typical that the plug-in, which has established a TCP session with a destination network entity and sent the translated message (step 608, FIG. 6) through the outgoing pipe, will execute a thread that awaits a response message, or multiple response messages, on the incoming pipe.

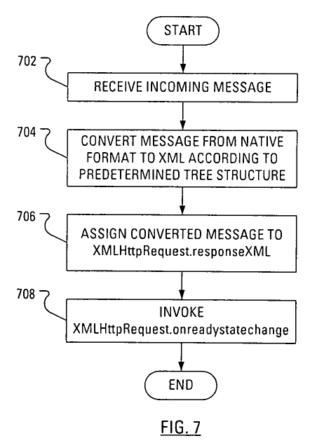

Steps of an example method of handling an incoming message by a plug-in are illustrated in FIG. 7. Initially, the plug-in receives (step 702) an incoming message. The plug-in then converts (step 704), according to a predetermined tree structure, the received message from the native protocol format to a message in a data interchange format that facilitates script access, thereby resulting in a converted message. The plug-in then assigns (step 706) the converted message to the property XMLHttpRequest.responseXML and invokes (step 708) a handler previously assigned to the XMLHttpRequest.onreadystatechange property. As should be clear to a person of ordinary skill in the art, more than one message may be received responsive to the message sent in step 608 (FIG. 6).

The handler previously assigned to the XMLHttpRequest.onreadystatechange property can be a JavaScript function that is part of the browser-based communication client application.

One API that may be used by a script code to access an object, where the object has a predetermined tree structure, is the known Document Object Model (DOM). The DOM is an API that has been standardized by the W3C (see www.w3.org/DOM/) and may be used by script code in a web page to manipulate HTML and XML data.

An alternative to the DOM is ECMAScript for XML, or “E4X” (formally known as ECMA-357, see www.ecma-international.org/publications/standards/Ecma-357.htm), which provides for traversing XML trees in the upcoming version of the known scripting programming language called ECMAScript. The standards body responsible for ECMAScript is Ecma International—European association for standardizing information and communication systems.

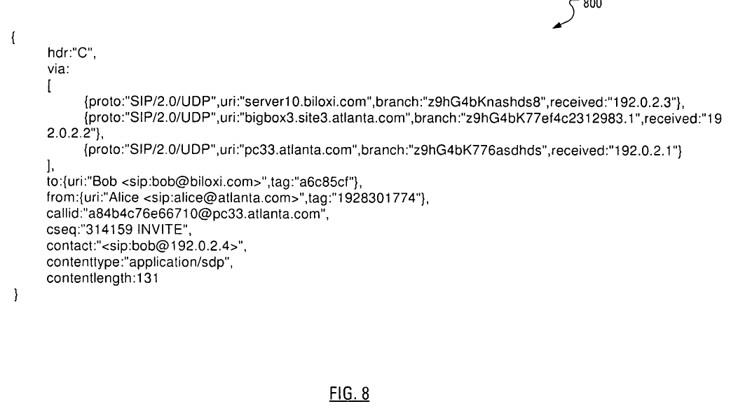

Notably, while XML has been presented hereinbefore as the example data interchange format that facilitates script access, other formats are available, such as JavaScript Object Notation (JSON). JSON is a lightweight computer data interchange format that is a text-based and human-readable that can be used for representing simple data structures and associative arrays (called objects). FIG. 8 illustrates an example of a result of mapping the SIP message of FIG. 2 to a JSON message.

While, thus far, only SIP has been discussed as a protocol for use in placing a voice call over a data network, other non-SIP protocols are also suitable for the task. For instance, a person of ordinary skill in the art should be aware of the known Q.931 protocol. Q.931 is a layer 3 protocol, mainly used for Integrated Services Digital Network (ISDN) voice call establishment, maintenance, and release of network connections between two network elements. Accordingly, while it is proposed above to extend the XMLHttpRequest API to accept non-HTTP URLs, it is specifically proposed herein that the XMLHttpRequest.open method be extended to accept a Q.931 URL.

Many major browsers, e.g., Internet Explorer, Firefox, have extension mechanisms that can be used to introduce the above-described logic. For example, in Microsoft™ Internet Explorer, XMLHttpRequest is an ActiveX object. To deploy a web-based unified communication client that adopts many of the novel aspects of the above description, it will not be necessary to wait for extensions to be implemented by the browser vendor.

Advantageously, the proposed extensions to XMLHttpRequest are backward compatible.

The development of a server-side translation layer is often a major stumbling block in the way of many major vendors refreshing their Private Branch Exchange (PBX) offerings for unified communications. Conveniently, the browser extensions described in this disclosure allow web-based unified communication clients to be deployed with existing SIP-based and non-SIP but IP-connected telephony servers without server-side changes.

The above-described embodiments of the present application are intended to be examples only. Alterations, modifications and variations may be effected to the particular embodiments by those skilled in the art without departing from the scope of the application, which is defined by the claims appended hereto.

What is claimed is:

1. An XMLHttpRequest Application Programming Interface (API) operable to process a non-Hyper-Text Transfer Protocol (non-HTTP) uniform resource locator (URL).

2. The XMLHttpRequest API of claim 1 wherein said non-HTTP URL is a Session Initiation Protocol URL.

3. The XMLHttpRequest API of claim 1 wherein said non-HTTP URL is a Q.931 URL.

4. An apparatus comprising a processor adapted to execute an XMLHttpRequest Application Programming Interface (API) operable to process a non-Hyper-Text Transfer Protocol (non-HTTP) uniform resource locator (URL).

5. A computer readable medium containing computer-executable instructions that, when performed by a processor, cause said processor to execute an XMLHttpRequest Application Programming Interface (API) operable to process a non-Hyper-Text Transfer Protocol (non-HTTP) uniform resource locator (URL).

6. A method of sending a message in a non-XML protocol, said method comprising:
receiving user input;
based on said user input, generating, in a given data interchange format and according to a predetermined tree structure, a message to be sent, where said given data interchange format facilitates script access;
creating an object to contain said message to be sent;
through calls to an application programming interface:
causing said message to be sent to be translated, according to said predetermined tree structure, to a message in said non-XML protocol; and
causing said message in said non-XML protocol to be transmitted.

7. The method of claim 6 wherein said generating said message comprises using the known document object model (DOM) to access and update said predetermined tree structure associated with said message.

8. The method of claim 6 wherein said generating said message comprises using ECMAScript for XML (E4X) to access and update said predetermined tree structure associated with said message.

9. The method of claim 6 wherein said given data interchange format is an Extensible Markup Language.

10. The method of claim 6 wherein said given data interchange format is JavaScript Object Notation.

11. An apparatus comprising a processor adapted to:
receive user input,
based on said user input, generate, in a given data interchange format and according to a predetermined tree structure, a message to be sent, where said given data interchange format facilitates script access;
create an object to contain said message to be sent;
through calls to an application programming interface:
cause said message to be sent to be translated, according to said predetermined tree structure, to a message in said non-XML protocol; and
cause said message in said non-XML protocol to be transmitted.

12. The apparatus of claim 11 wherein said generating said message comprises using the known document object model (DOM) to access and update said predetermined tree structure associated with said message.

13. The apparatus of claim 11 wherein said generating said message comprises using ECMAScript for XML (E4X) to access and update said predetermined tree structure associated with said message.

14. The apparatus of claim 11 wherein said given data interchange format is an Extensible Markup Language.

15. The apparatus of claim 11 wherein said given data interchange format is JavaScript Object Notation.

16. A computer readable medium containing computer-executable instructions that, when performed by a processor, cause said processor to:
receive user input,
based on said user input, generate, in a given data interchange format and according to a predetermined tree structure, a message to be sent, where said given data interchange format facilitates script access;
create an object to contain said message to be sent;
through calls to an application programming interface:
cause said message to be sent to be translated, according to said predetermined tree structure, to a message in said non-XML protocol; and
cause said message in said non-XML protocol to be transmitted.

17. The computer readable medium of claim 16 wherein said generating said message comprises using the known document object model (DOM) to access and update said predetermined tree structure associated with said message.

18. The computer readable medium of claim 16 wherein said generating said message comprises using ECMAScript for XML (E4X) to access and update said predetermined tree structure associated with said message.

19. The computer readable medium of claim 16 wherein said given data interchange format is an Extensible Markup Language.

20. The computer readable medium of claim 16 wherein said given data interchange format is JavaScript Object Notation.

21. A method of handling an incoming message in a non-XML protocol, said method comprising:
receiving said incoming message;
based on said incoming message, generating, in a given data interchange format and according to a predetermined tree structure, a received message, where said given data interchange format facilitates script access; and
invoking a handler to process said received message.

22. The method of claim 21 wherein said generating said received message comprises using the known document object model (DOM) to access and update said predetermined tree structure associated with said received message.

23. The method of claim 21 wherein said generating said received message comprises using ECMAScript for XML (E4X) to access and update said predetermined tree structure associated with said received message.

24. The method of claim 21 wherein said given data interchange format is an Extensible Markup Language.

25. The method of claim 21 wherein said given data interchange format is JavaScript Object Notation.

26. An apparatus comprising a processor adapted to:
receive an incoming message;
based on said incoming message, generate, in a given data interchange format and according to a predetermined tree structure, a received message, where said given data interchange format facilitates script access; and
invoke a handler to process said received message.

27. A computer readable medium containing computer-executable instructions that, when performed by a processor, cause said processor to:
receive an incoming message;
based on said incoming message, generate, in a given data interchange format and according to a predetermined tree structure, a received message, where said given data interchange format facilitates script access; and
invoke a handler to process said received message.
